(19) United States
(12) Patent Application Publication
(10) Pub. No.: US 2007/0096483 A1
(43) Pub. Date: May 3, 2007

(54) Scooping device

(76) Inventors: Raymond M. Binkowski, East Amherst, NY (US); Jacqueline J. Smith, East Amherst, NY (US)

Correspondence Address: Crossetta & Associates, 905 Convention Towers, 43 Court Street, Buffalo, NY, 14202, US

(21) Appl. No.: 11/261,956

(22) Filed: Oct. 31, 2005

(51) Int. Cl. A01K 29/00

(52) U.S. Cl. 294/1.3

(57) ABSTRACT

A scoop for the collection of animal refuse comprising a housing having an interior hollow containing an opposing entry and egress opening, the housing having a top wall, opposing side guide walls and a bottom wall arranged adjacent the entry and egress openings, with the bottom wall having an interior scooping surface with an upwardly curved scraping lip with a straight scraping edge for scooping animal waste onto an interior scooping surface of the bottom wall and the egress opening being surrounded by a mounting shoulder extending outwardly from the housing, which is arranged to accept a mounting collar for removably mounting a pliant collection bag to it.

This invention relates generally to devices for scooping-up and disposing of animal excretory material deposited on a surface by a pet dog, cat or other animal.

### BACKGROUND OF THE INVENTION

Pet dogs and the like are typically trained to resist performing their excretory needs indoor, and to confine such needs to the outdoors. Generally pet owners believe this comprises no problem to the environment and the pet is typically encouraged to deposit its waste in any open land where it can naturally decompose over time. In urban and suburban communities, the deposit of animal waste in parks, on sidewalks and other places where the public walks and/or plays is not tolerated and pet owners are faced with laws which mandate that those responsible for a dog or other pet animal, promptly remove solid animal refuse deposited by their pet on a sidewalk or other outdoor sites frequented by humans. Violation of such laws may subject pet owners to significant fines, and responsible owners are encouraged to comply with the laws. Because solid animal refuse may contain harmful bacteria, worms and the like which could present health hazards to humans and other animals, a sanitary and efficient way to pick up and dispose of such refuse is needed which protects the pet owner from being inadvertently soiled or contaminated during the process.

Collecting fresh animal refuse from the grass or sidewalk using a typical dust pan and brush as one would collect dirt, is messy and generally leaves the pan and brush unsuitably soiled and contaminated with the animal refuse, creating a health hazard. Training a pet dog to deposit excretory matter on a sheet of newspaper or the like is difficult and leaves the owner with an unpleasant disposal problem. The common technique of using a disposable and/or the like glove to pick up the animal refuse, lends new meaning to the term hands-on refuse collection, and is certainly found by many to be a distasteful solution to the problem.

U.S. Pat. No. 4,875,729 to Peck, provides a triangular frame having a handle attached at its apex for collecting animal refuse, the frame being inserted into a small biodegradable bag so that the broad base of a frame is adjacent the closed end of the biodegradable bag covering the frame. One drawback of this device is that it is difficult to effectively collect animal refuse when using it, and it requires significant manipulation technique to attach and remove the bag to and especially from the frame.

U.S. Pat. No. 4,958,871 to Hemans discloses a hand-held device for picking up animal waste which uses a device with a fold-lock-top sandwich bag as the receptacle for waste material. A problem of this collection device is that the hook provided to hold the sandwich bag firmly in place can tear the bag under even minor stress, which can interfere with picking up the animal waste and cause the bag to fall away from the blade, and spilling of the waste contained therein.

Dog refuse is generally excrement, and the handling of disease-bearing animal excrement is not only a repellent activity, but one in which there is a risk of contamination. While dog owners may wish to conform with animal refuse laws, such laws are nevertheless disobeyed by many dog owners due to the difficulties with prior art refuse collection means.

### SUMMARY OF THE INVENTION

A unique scoop with detachable bag assembly is described herein, arranged to allow convenient scooping-up and act as a repository for waste material and/or animal refuse deposited on a variety of surfaces by a pet animal. In a preferred embodiment, the scoop comprises a housing having an entry end, an egress end, a top wall, opposing side walls referred to as guide walls, and a bottom wall having an inner scooping surface. The entry end comprises an entry opening having a generally straight scraping edge for scooping animal waste onto the inner scooping surface of the bottom wall. The egress end comprises an egress opening generally sized smaller than the entry opening. Guide walls are generally angled, curved or the like arranged to guide refuse along the scooping surface from the entry opening to the smaller egress opening. The egress opening of the scoop is a generally round opening having a raised mounting shoulder extending outwardly from the housing. The scoop preferably comprises a top wall connecting to the guide walls, so that the guide walls, top wall and scooping surface form a housing having a large entry opening with a generally straight scraping edge arranged to detach fresh excrement from a surface and guide it through a smaller egress opening to a collection bag. In a preferred embodiment, the top wall comprises a handle arranged along the exterior surface of the housing to enable convenient hand manipulation of the housing.

The raised mounting shoulder extends outwardly from the egress end of the housing generally surrounding the egress opening and is configured to enable removably attaching a flexible disposable bag into which scooped material can be guided. Any suitable means for attaching the disposable bag can be used, but in a preferred embodiment the exterior surface of the raised shoulder is threaded and an interior threaded, hollow cylindrical mounting collar is provided having mating threads for attachment of the mounting collar to the raised shoulder. The mounting collar is preferably a generally cylindrical body opening at opposite ends with the threaded interior thereof arranged to loosely mate with the threaded exterior wall of the mounting shoulder, so that the open end of a flexible disposable bag can be gathered and inserted through the generally cylindrical body of the mounting collar onto the raised threaded shoulder generally surrounding the egress opening. The mounting collar is then threaded on the mating threaded mounting shoulder generally surrounding the egress opening, to frictional retain the disposable bag between the mounting collar and the raised shoulder, leaving a clear egress opening into the disposable bag.

In the system of the invention the open end of a flexible disposable bag is inserted through the cylindrical body and locked into place by threading or otherwise mounting the cylindrical body to the raised mounting shoulder. The generally straight edge of the entry opening engages a deposit surface containing the fresh refuse, separating the refuse from the deposit surface and onto the interior scooping surface of the scoop. The entry end of the scoop is raised and the refuse slides toward and through the egress opening into the disposable bag. The bag can be retained on the scoop for one or more uses and when desired, the mounting collar is unscrewed and the bag conveniently removed and the opening thereof secured for appropriate disposal.

Disposable bags can be any convenient flexible bag of any convenient size. Thus for example, a suitable flexible bag can be a common plastic, paper and/or biodegradable bag purposely gathered and/or sized with so that the open end fits around the shoulder of the egress opening and/or held in place with a mounting collar as desired. In a typical arrangement, commonly available open ended bags such as typical plastic or paper bags used by retailers to package grocery or other goods. Thus the open end of a commonly available plastic grocery bag, is inserted through the mounting collar and reversed over the mounting collar for attachment to the mounting shoulder of the egress end. In a situation wherein refuse clings to the scooping surface, a wet paper towel or the like may be used to clean the scooping surface before removal of the bag and the paper towel washed through exit opening into the plastic bag for sanitary disposal.

The housing can be manufactured from any suitable material, but preferably is formed from a plastic. Commonly available non-sticking plastics are particularly preferred, such plastics generally containing additives and/or surface coatings which resist the tendency of fresh refuse to stick to the scooping surface, guide or top wall surfaces as it is directed toward the egress opening. Similarly, it is generally preferred that corners among the guide walls, scooping surface, top surface and egress opening be curved so as to promote sliding of the refuse along the scooping surface and through the exit opening with minimal retention of refuse.

In a preferred embodiment, the entry end of the housing comprising the generally straight edge along the entry opening to the housing is curved upwardly from an otherwise generally flat bottom wall of the housing. The manipulating action of scooping up matter from a ground surface when in a standing position typically involves a pendulum like manipulation which first dislodges the matter by propelling it forward, then catching the matter by stopping its forward movement by manipulation of the scooping surface. Scooping over an edge along a generally horizontal scooping surface requires manipulating skill and timing in aligning the scooping edge to the matter to be scooped up and timing the upward and forward movement necessary to keep the scooped material from flying away from the scooping surface. Upwardly curving the entry end of the scooping surface so that the scooping surface is at an angle to the ground at the initiation of the scooping process assures that the curved scooping entry end will be in a barrier position at the end of the pendulum manipulation, to retain the matter from the continued forward movement imparted by the scraping action.

The handle can be any suitable means for grasping and manipulating the device as a scoop. In a preferred embodiment, a handle is positioned along the exterior of a top wall to protect the user from inadvertently engaging the animal refuse. The handle may extend outwardly from the top wall, but generally it is preferred that the top wall comprise an elongate indentation with the handle spanning the length thereof, the indentation enabling the user to grasp the handle. Such handle provides the user with protection from inadvertent soiling, while enabling a shape to the scoop which allows convenient stacking or the like.

### BRIEF DESCRIPTION OF THE DRAWINGS

For a more complete understanding of this invention, reference is now made to the following accompanying drawings, wherein:

FIG. 1 is an exploded perspective view of a scooping device of the invention with collection bag illustrated in phantom;

FIG. 2 is a front plan view of the device of FIG. 1;

FIG. 3 is a right side plan view of the device of FIG. 1;

FIG. 4 is a rear plan view of the device of FIG. 1; and

FIG. 5 is a perspective view of the mounting collar of FIG. 1.

### DETAILED DESCRIPTION OF THE DRAWINGS

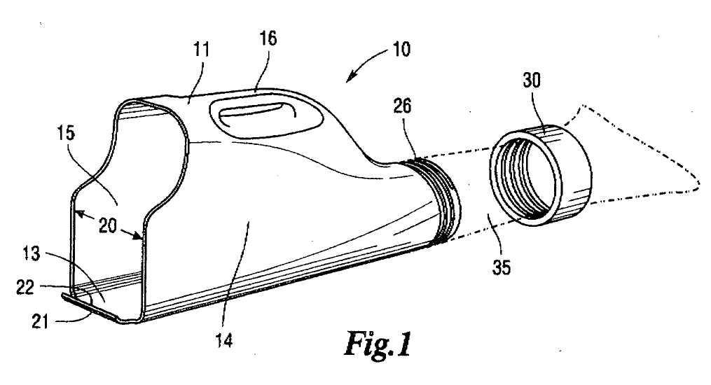

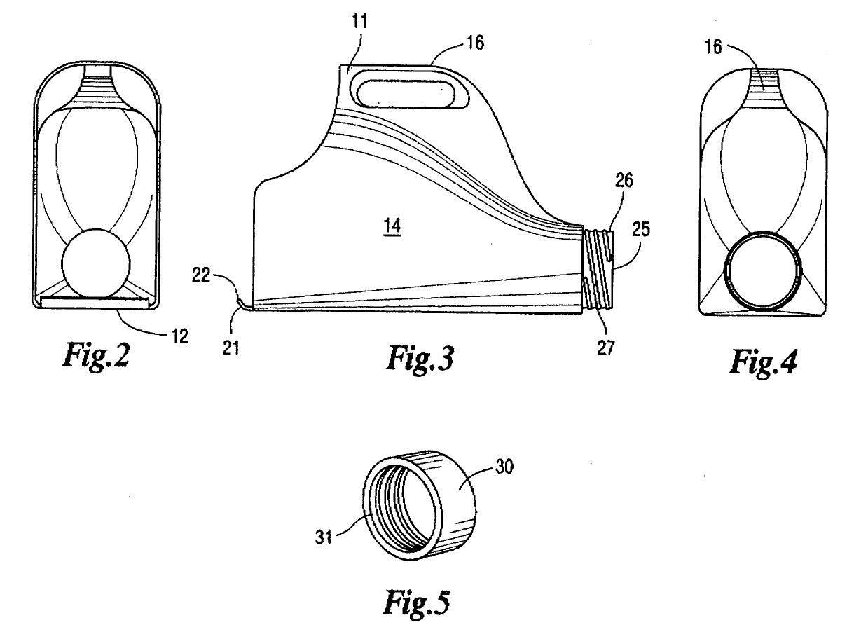

FIGS. 1-5 illustrate a preferred embodiment of the invention wherein scoop 10 comprises: top wall 11; bottom wall 12 having interior scooping surface 13; guide walls 14 and 15; entry opening 20 having lip 21 and scraping edge 22; egress opening 25; mounting shoulder 26 having exterior mounting threads 27; mounting collar 30 with interior threading 31; and collection bag 35.

In the preferred embodiment, scoop 10 is formed, molded or the like from commonly available plastics, with corners connecting top, bottom, sides and egress opening, being rounded to resist accumulation of refuse material thereat. Top wall 11 is illustrated as comprising handle 16, which is sized and dimensioned to enable convenient hand gripping of the scoop for retrieving animal refuse. Scraping lip 21 is illustrated as preferably upwardly rounded from interior scooping surface 13 and scraping edge 22 is illustrated as preferably being generally straight. Upwardly rounding of scraping lip 21 enables a more ergonomically efficient manipulation of the scraper through a pendulum-like scooping movement by the user, in that the center of gravity of the user can be conveniently stationed generally at or forward of the refuse being collected at the initiation of the scooping action, reducing the possibility that refuse will be lifted forward and thrown from the scoop during the scooping manipulation. The generally straight scraping edge is generally desirable for convenient scraping-up of animal refuse which may be sticking to a surface or the like.

In the illustrated embodiment, hollow mounting collar 20 enables the removable attachment of the collection bag to the mounting shoulder of the scooping device. Thus, the gathered open end of a pliant bag is illustrated as being inserted through the hollow interior of the mounting collar, the gathered end is reversed over the collar and the collar is threaded onto the mounting shoulder surrounding the egress of the device. Animal refuse is collected on the scooping surface of the interior of the housing by scooping, and movement of device so that the scooping surface is generally aligned toward vertical allows the animal waste to fall downwardly through the egress and into the interior of the collection bag. The bag can be used for multiple separate collections, can be conveniently changed after each use, or may be used for different collecting problems.

Thus, a pet owner attending to a pet using the scoop of the invention fitted with a liquid holding pliant collection bag may scoop up fresh droppings from such pet may find the interior of the device has become fouled from sticking refuse and may rinse the interior of the device with water and using a disposable towel or the like may collect the water, towel and dropping within the pliant bag for disposal after a single use. Another pet owner may allow droppings from a pet to accumulate and dry out in an area such as a small yard or the like before collecting the accumulation in a single collection bag. These and other uses and functions of the scoop of the invention are contemplated as being within the scope of the invention as hereinafter claimed.

I claim:

1. A scoop for the collection of animal refuse comprising:
a housing having an interior hollow containing an opposing entry and egress opening;
said housing having a top wall, opposing side guide walls and a bottom wall arranged adjacent said entry and egress openings, said bottom wall having an interior scooping surface;
said entry opening having a generally straight scraping edge for scooping animal waste onto said interior scooping surface of said bottom wall;
wherein said egress opening is surrounded by a mounting shoulder extending outwardly from said housing, which is arranged for removably mounting a pliant collection bag thereto.

2. The scoop of claim 1 wherein said egress opening has a smaller perimeter than the perimeter of said entry opening, and said guide walls are angled from adjacent about the perimeter of the entry opening to adjacent about the smaller perimeter of the egress opening.

3. The scoop of claim 2 wherein said top wall is angled from adjacent about the perimeter of the entry opening to adjacent about the smaller perimeter of the egress opening.

4. The scoop of claim 1 comprising a mounting collar arranged to removably surround the exterior surface of said mounting shoulder.

5. The scoop of claim 1 wherein the exterior surface of said mounting shoulder is threaded.

6. The scoop of claim 5 comprising a mounting collar having a threaded interior surface arranged to mate with the threaded exterior surface of said mounting shoulder.

7. The scoop of claim 6 wherein said mounting shoulder and said mounting collar are generally cylindrical.

8. The scoop of claim 7 wherein pliant material adjacent the perimeter of an open end of said pliant collection bag is mounted to surround said threaded exterior surface of said mounting shoulder, and the threaded interior surface of said mounting collar is mounted to removably engage said pliant material adjacent the said open end of said pliant collection bag and forcibly retain said pliant collection bag to said mounting shoulder.

9. The scoop of claim 1 comprising a handle.

10. The scoop of claim 10 wherein said handle is positioned along the exterior of the top wall of said housing.

11. The scoop of claim 10 wherein said top wall of said housing comprises an elongate indentation and said handle spans said indentation.

12. The scoop of claim 1 wherein said generally straight scraping edge is arranged along the bottom wall of said housing.

13. The scoop of claim 12 wherein said scraping edge is arranged along a scraping lip, extending upwardly from said bottom wall of said housing.

14. The scoop of claim 13 wherein said scraping lip curves upwardly from said bottom wall of said housing.

15. The scoop of claim 1 wherein corners between said side guide walls and said top and bottom walls are rounded.

16. The scoop of claim 1 wherein corners between said side guide walls, top wall, bottom wall and the perimeter of said egress opening are curved.
